(19) United States
(12) Patent Application Publication
(10) Pub. No.: US 2016/0281367 A1
(43) Pub. Date: Sep. 29, 2016

(54) ORNAMENTAL VINYL BUILDING ARTICLE

(71) Applicant: Guodong Jiang, Milwaukee, WI (US)

(72) Inventor: Guodong Jiang, Milwaukee, WI (US)

(21) Appl. No.: 15/167,377

(22) Filed: May 27, 2016

Related U.S. Application Data
(63) Continuation-in-part of application No. 15/161,034, filed on May 20, 2016.
(60) Provisional application No. 62/333,030, filed on May 6, 2016.

(51) Int. Cl. E04F 13/08; B29C 47/00; B29C 65/02; E04F 13/18; B29C 35/16; B32B 5/20; B32B 7/12; B32B 27/30; B29B 7/88; B29C 69/00

(52) U.S. Cl. CPC E04F 13/0866; B29B 7/88; B29C 47/0028; B29C 47/0064; B29C 65/02; B29C 69/001; B29C 35/16; B32B 5/20; B32B 7/12; B32B 27/304; E04F 13/185; B29C 2035/1616; B29K 2627/06

(57) ABSTRACT

The present invention is an ornamental vinyl building article made up of a high-strength, extruded base molecularly bonded to a variable texture pattern layer. The variable texture pattern layer provides a highly representational and customizable surface appearance to the article, allowing it to mimic wood and stone building materials used for baseboards, panels, rails, moldings, carvings, friezes, and tiles. The extruded base includes polyvinyl chloride (PVC), nanoscale particles of chemically synthesized calcium carbonate, foaming agent, PVC plasticizer, lubricant, toughening agent, and thermal stabilizer. Once extruded, one surface of the extruded base is heated to allow a molecular bond interface to form between the extruded base and the variable texture pattern layer.

### CROSS-REFERENCE TO RELATED APPLICATIONS

This patent application claims the benefit of U.S. Provisional Application No. 62/333,030 filed May 6, 2016. This application is a continuation-in-part and claims the benefit of U.S. patent application Ser. No. 15/161,034 filed May 20, 2016. The above applications are incorporated by reference herein in their entirety.

### FIELD OF INVENTION

This invention relates to the field of stock materials and more specifically to a non-toxic, highly representational vinyl article of manufacture that emulates the appearance and texture of multiple natural materials (e.g. wood and stone) without retooling of equipment.

### BACKGROUND OF THE INVENTION

Vinyl is a material that has been used primarily for flooring since the 1940's and accounts for 80 percent of all flooring sales in the U.S. Consumer preferences have evolved to create consistent demand for vinyl products that have the appearance of wood, stone, or other natural products. Consumers perceive the quality of vinyl products relative to how realistically the product emulates the appearance of natural materials such as wood and stone.

However, despite proven demand for realistic flooring products, there has been little effort to tap into the likely consumer market for other synthetic home décor products which offer the appearance of natural wood and stone. Technology has focused solely on the flooring market, and current vinyl fabrication processes cannot be adapted to satisfy consumer demand for other products (such as chair rails, crown moldings, friezes, carved ornamentation, etc.)

Luxury Vinyl Tile (LVT) is currently the most popular type of flooring on the market. To be marketed as LVT, manufacturers must comply with ISO Standard 14025. Compliance with the standard creates a thin base article upon which an image is laminated. The ISO Standard for producing LVT requires the step of “calendaring,” a process by which materials are pressed between two rollers to smooth the surface and create a flat tile less than a centimeter thick with a smooth surface. The calendaring process is necessary to ensure to that surface of the manufactured article is perfectly smooth and devoid of imperfections which may cause the lamination process to fail.

Because LVT known in the art must have a smooth surface and a uniform thickness of less than a centimeter, it is not possible to produce a range of decorative building materials with three-dimensional, contoured surfaces, such as crown moldings, which emulate stone and wood. The use of LVT is limited to flooring or flat wall coverings.

Current formulations of the vinyl compound used to form the base article have been developed specifically to create a two-dimension vinyl article that is less than a centimeter thick, and manufactured as either a tile or plank.

Printing processes for luxury vinyl are also designed for two-dimensional articles. Current imaging processes known in the art have been developed for flat, uniform surfaces. It is not possible to use LVT imaging processes known in the art for non-flat decorative surfaces, such as surfaces representing carved crown moldings and chair rails. Additionally, LVT imaging processes known in the art cannot produce surfaces that emulate more subtle textures, such as the feel of wood grain, the smoothness of polished mahogany or the hard glossy feel of marble, and are limited to embossing methods.

Current LVT can only be given a texture by embossing the laminated surface. Manufacturers cannot rapidly introduce new patterns to conform to shifts in consumer taste and demand, due to the need to create new embossing plates. Moreover, embossing can only produce a limited amount of textures and patterns that must repeat at regular intervals, resulting in a less authentic appearance of the product.

Additionally, many vinyl lamination processes continue to use materials which include toxins such as heavy metals and formaldehyde, even though a product is ISO complaint. For example, U.S. Pat. No. 7,763,345 for Adura®, produced by Mannington Mills, Inc. in Salem, N.J. teaches a laminate soaked in formaldehyde and covered by urethane. These chemicals, even if released into a home or the environment at minute levels, may be perceived as unsafe by consumers. Once accepted for use, it is difficult for retailers to monitor quantities and percentages of “trace” elements within an ISO-compliant material.

It is desirable to have a vinyl production process that can create realistic, unique, and seemingly infinite patterns of materials found in nature.

It is further desirable to have manufacturing technology that can rapidly respond to consumer taste and demand, and modify the finished products accordingly.

### BRIEF SUMMARY OF THE INVENTION

The present invention is an ornamental vinyl building article including a high-strength extruded base, a molecular bond interface, and a variable texture pattern layer. The extruded base is extruded from a composition including polyvinyl chloride (PVC), nanoscale particles of chemically synthesized calcium carbonate, foaming agent, PVC plasticizer, lubricant, toughening agent, and thermal stabilizer. The extruded base includes multiple external surfaces, one of which is connected to the pattern layer by the molecular bond interface. The pattern layer is a pattern or a solid color, and provides a highly representational and customizable surface appearance to the article.

The invention is produced by a method of manufacturing specific to the article. The method precipitates nanoscale particles of chemically synthesized calcium carbonate, combines them in the above composition, then extrudes and cools the above extruded base. To form the molecular bond interface, the method heats one surface of the extruded base and presses the pattern layer to the surface with a novel pressure application tool. This pressure application tool is conformable to the extruded base and is critical to process of bonding a pattern layer to a multi-dimensional extruded base.

### BRIEF DESCRIPTION OF SEVERAL VIEWS OF THE DRAWING(S)

FIG. 1 illustrates a cross-section of an exemplary embodiment of an ornamental vinyl building article.

FIG. 2 illustrates a flowchart of a method for manufacturing an exemplary embodiment of an ornamental vinyl building article.

### TERMS OF ART

As used herein, the term “adhesive layer” means a continuous or non-continuous layer of an adhesive substance.

As used herein, the term “bound” means non-removably connected.

As used herein, the term “chemically synthesized” means produced through a chemical reaction.

As used herein, the term “digitally stored” means stored as data in an electronic storage device.

As used herein, the term “foaming agent” means any substance, when added in an effective amount, capable of creating pockets of gas in a polymer through a chemical or physical process.

As used herein, the term “molecular bond interface” means a layer formed by the thermal- and/or pressure-induced intermingling of molecules of two adjacent layers.

As used herein, the term “molecular bonding temperature” means a temperature that allows intermingling of molecules of two adjacent layers.

As used herein, the term “multi-dimensional” or “three-dimensional” means having a substantially non-flat or non-planar shape which may or may not be further characterized by curvature, angles, contours, grooves, protrusions, or other surfaces.

As used herein, the term “nanoscale particles” means solid particles that have an average diameter of approximately 1000 nm or less and are precipitated or otherwise synthetically formed.

As used herein, the term “orthorhombic” means a crystalline shape having three unequal axes at right angles.

As used herein, the term “planar” means a substantially flat shape, without any angles, curves, protrusions, or depressions.

As used herein, the term “precipitation reaction” means a chemical reaction that forms a solid substance using one or more fluid solutions.

As used herein, the term “prismatic” means a crystalline shape having bases or ends that are parallel, congruent polygons and sides that are parallelograms.

As used herein, the term “rhombohedral” means a crystalline shape having six faces, each faces being a rhombus.

As used herein, the term “scalenohedral” means a crystalline shape having 8 or 12 faces, each face being a triangle with three unequal sides.

As used herein, the term “texture” means any discernible surface characteristic such as, but not limited to, smooth, rough, striated, patterned, or granular.

As used herein, the term “thermal stabilizer” means any substance added in an effective amount to a polymer to increase the polymer's resistance to heat.

As used herein, the term “toughening agent” means any substance added in an effective amount to a polymer to increase the polymer's resistance to impact. Such substances may include, but are not limited to, polymers, natural products, synthesized products, or combinations thereof.

As used herein, the term “variable pattern texture layer” means a layer where material used to form an image is also used to create a texture.

### DETAILED DESCRIPTION OF THE INVENTION

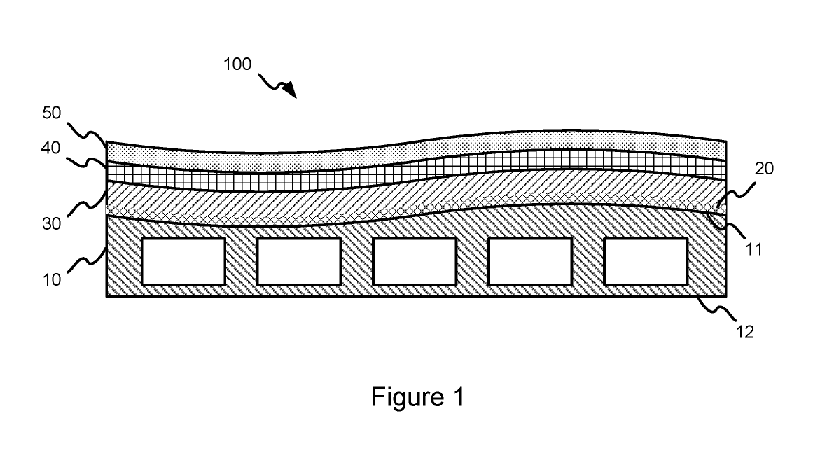

FIG. 1 illustrates a cross-section of an exemplary embodiment of ornamental vinyl building article 100. Ornamental vinyl building article 100 includes a high-strength extruded base 10 with a variable texture pattern layer 30 connected by a molecular bond interface 20. An adhesive layer 40 connects variable texture pattern layer 30 to a coating 50. Ornamental vinyl building article 100 is inflammable, in that it does not support combustion when exposed to an open flame in the atmosphere, due to the inclusion of an effective amount of nanoscale particles of chemically synthesized calcium carbonate in high-strength extruded base 10. Ornamental vinyl building article 100 may be formed in any configuration capable of being extruded. This may include baseboards, panels, rails, moldings, carvings, tiles, friezes, or any other decorative building article known in the art.

High-strength extruded base 10 includes multiple surfaces, including a first external surface 11 and a second external surface 12. Due to heat treatment and/or the bonding of variable texture pattern layer 30 via molecular bond interface 20, first external surface 11 is harder than second external surface 12. High-strength extruded base 10 is extruded from a composition of polyvinyl chloride (PVC), nanoscale particles of chemically synthesized calcium carbonate, at least one foaming agent, at least one PVC plasticizer, at least one lubricant, at least one toughening agent, and at least one thermal stabilizer.

The nanoscale particles of chemically synthesized calcium carbonate have an average diameter of less than 1000 nm. In one embodiment, nanoscale particles of chemically synthesized calcium carbonate have an average diameter of between approximately 50 nm and approximately 500 nm. The nanoscale particles of calcium carbonate form by a chemical reaction, not by reduction from larger pieces or particles. This is critical, as chemically-produced calcium carbonate is more structurally uniform. This structural uniformity is found in a smaller, more consistent particle size, allowing for increased impact resistance of plastics it is added to. Chemically synthesized calcium carbonate also has a more consistent shape, giving more control over physical properties such as powder density, surface area, and particle absorption. The shape of the nanoscale particles of chemically synthesized calcium carbonate may include scalenohedral, rhombohedral, prismatic, or orthorhombic crystals. Producing calcium carbonate through a chemical reaction also allows increased purity and removal of potentially dangerous substances, such as heavy metals. In the exemplary embodiment, the nanoscale particles of chemically synthesized calcium carbonate form by a precipitation reaction.

In the exemplary embodiment, the composition includes between approximately 50 wt % and approximately 75 wt % of PVC, between approximately 25 wt % and approximately 30 wt % of nanoscale particles of chemically synthesized calcium carbonate, between approximately 1 wt % and approximately 2 wt % of foaming agent, between approximately 2 wt % and approximately 3 wt % of non-orthophthalate PVC plasticizer, approximately 1 wt % of lubricant, approximately 2 wt % of non-PVC thermoplastic polymer as a toughening agent, and approximately 4 wt % of thermal stabilizer. In the exemplary embodiment, the non-orthophthalate PVC plasticizer is dioctyl terephthalate (DOTP). The lubricant is selected from a group consisting of: hydrocarbon-based lubricants and fatty acid-based lubricants. In the exemplary embodiment, the lubricant is paraffin. In the exemplary embodiment, the non-PVC thermoplastic polymer is acrylonitrile butadiene styrene (ABS), and the thermal stabilizer is calcium and zinc based. In certain embodiments, the composition also includes between approximately 1 wt % and approximately 2 wt % of stearic acid to protect against heat and cold damage, and reduce material oxidation. The composition does not contain orthophthalates, processing aids such as PVC-acrylic, or heavy metal-based stabilizers.

In certain embodiments, high-strength extruded base 10 includes one or more hollow chambers extending along a long axis or in extruded direction to provide a multi-dimensional shape or to reduce weight (as compared to conventional materials). Weight reduction allows a better weight-to-volume ratio that may reduce shipping costs. In certain embodiments, first external surface 11 may be flat or multi-dimensional.

Molecular bond interface 20 is formed by the thermal- and/or pressure-induced intermingling of first external surface 11 and variable texture pattern layer 30. This results in variable texture pattern layer 30 at least partially merging with first external surface 11, providing a strong bond between layers.

Variable texture pattern layer 30 is molecularly bonded to external surface 11 and is made up of any substance which can represent a computer-generated image or appearance. In the exemplary embodiment, variable texture pattern layer 30 is fabricated from at least one colored polymer. Variable texture pattern layer 30 may be a multi-colored pattern or a solid color. Any type of texture may be fabricated using a three-dimensional printer, reducing the equipment needed to produce ornamental vinyl building article 100.

Patterns used to fabricate variable texture pattern layer 30 may be digitally stored or generated, allowing a wide array of patterns mimicking stone, wood, or any other building materials. In certain embodiments, the patterns are digital copies or photographs of existing building materials, such as, but not limited to, stone, ceramic, or wood. In other embodiments, the patterns are generated using computer software. Such embodiments may utilize a randomization algorithm during generation to prevent patterns from repeating over time, providing a more realistic appearance to ornamental vinyl building article 100.

Adhesive layer 40 joins coating 50 to variable texture pattern layer 30. Adhesive layer 40 is a transparent, waterproof, non-toxic adhesive. In the exemplary embodiment, adhesive layer 40 is a silicone-based adhesive.

Coating 50 is the transparent uppermost layer of ornamental vinyl building article 100 and is selected from the group consisting of aluminum oxide and urethane. Coating 50 prevents wear, oxidation, and ultraviolet (UV) damage of all remaining layers. Coating 50 may also impart a glossy, semi-gloss or matte finish to ornamental vinyl building article 100.

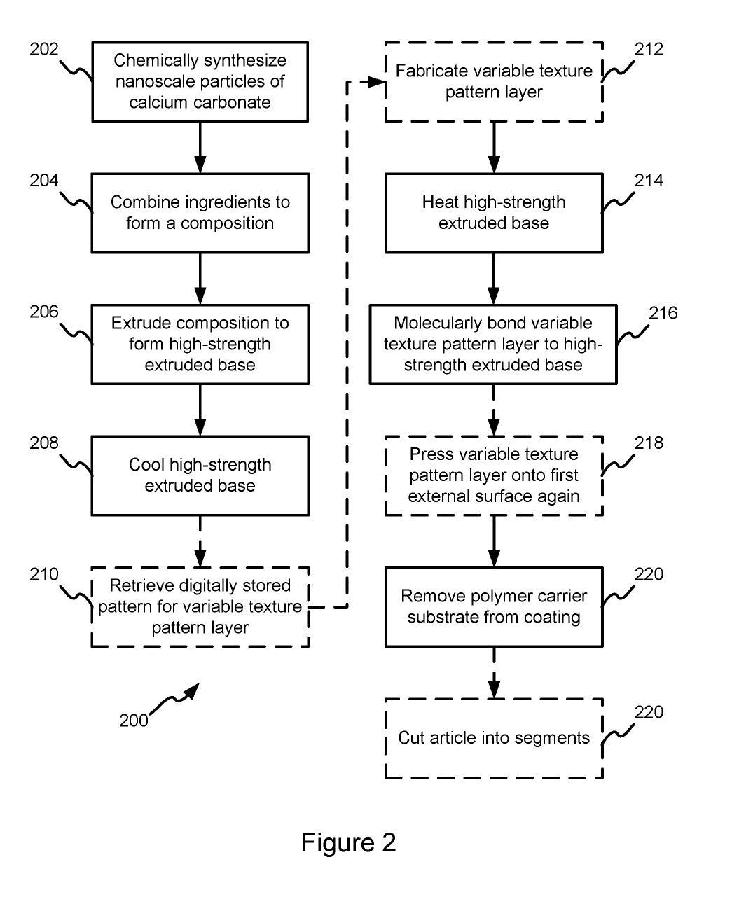

FIG. 2 illustrates a flowchart of a method 200 for manufacturing an exemplary embodiment of ornamental vinyl building article 100.

In step 202, method 200 chemically synthesizes nanoscale particles of calcium carbonate having an average diameter of less than 1000 nm. In the exemplary embodiment, this is a precipitation reaction. In one embodiment, the nanoscale particles of chemically synthesized calcium carbonate have an average diameter of between approximately 50 nm and approximately 500 nm. This step is critical to ensuring particles of the correct structure (i.e., size and shape).

In step 204, method 200 combines polyvinyl chloride (PVC), nanoscale particles of chemically synthesized calcium carbonate, at least one foaming agent, at least one PVC plasticizer, at least one lubricant, at least one toughening agent, and at least one thermal stabilizer to form a composition. One embodiment utilizes a hot-cold mixer to combine the ingredients at a high temperature to drive off any contaminants, and then continues to combine at a lower temperature in a controlled atmosphere to prevent recontamination.

In step 206, method 200 extrudes the composition to form high-strength extruded base 10. The heat, pressure, and shear of the composition's passage through the extruder melts and combines the composition ingredients. In one embodiment, the extruder is a double-screw extruder. High-strength extruded base 10 can be extruded as a flat sheet or multi-dimensional cross-sectional shape. In one embodiment, high-strength extruded base 10 has one or more hollow chambers extending along the direction of extrusion.

In step 208, method 200 cools high-strength extruded base 10 to stabilize its shape and prevent deformation. In one embodiment, high-strength extruded base 10 passes through a tank. In certain embodiments, this tank is filled with cold water.

In optional step 210, method 200 retrieves a digitally stored pattern. In certain embodiments, the digitally stored patterns are digital copies or photographs of existing building materials, such as, but not limited to, wood, stone, or other natural building materials. In other embodiments, the digitally stored patterns are generated using computer software. Such embodiments may utilize a randomization algorithm during generation to prevent patterns from repeating over time, providing a more realistic appearance to ornamental vinyl building article 100.

In optional step 212, method 200 fabricates variable texture pattern layer 30 on an upper surface of a carrier tape 60. Carrier tape 60 includes a polymer carrier substrate 61, coating 50, and adhesive layer 40. The surface of polymer carrier substrate 61 determines whether coating 50 will have a glossy, semi-gloss, or matte finish. After fabrication, variable texture pattern layer 30 is located on top of adhesive layer 40. In one embodiment, the polymer carrier substrate 61 is polyethylene terephthalate (PET). An exemplary embodiment of method 200 utilizes a three-dimensional printer, which may fabricate variable texture pattern layer 30 with any texture without requiring changes to the equipment.

In step 214, method 200 heats high-strength extruded base 10 and/or carrier tape 60 to a molecular bonding temperature to create molecular bond interface 20 between high-strength extruded base 10 and variable texture pattern layer 30. In the exemplary embodiment, this temperature ranges from approximately 100 degrees Celsius to approximately 200 degrees Celsius. Steps 214 and 216 may be performed simultaneously.

In step 216, method 200 molecularly bonds variable texture pattern layer 30 to high-strength extruded base 10 using molecular bond interface 20. This is accomplished by pressing variable texture pattern layer 30 onto first external surface 11 using a heat transfer machine with a pressure application tool. In various embodiments, the pressure application tool is a solid mass of flexible material, a porous mass of flexible material, or a membrane of flexible material at least partially filled with fluid or a plurality of particles, such as beads or sand. In various embodiments, the pressure application tool may be deformed or inflated to conform to a surface. In the exemplary embodiment, the pressure application tool is a flexible, heat-resistant membrane at least partially filled with a fluid. The pressure application tool ensures that the machine applies uniform pressure to carrier tape 60 and first external surface 11, even with a multi-dimensional high-strength extruded base 10.

In optional step 218, method 200 again presses variable texture pattern layer 30 onto first external surface 11 using at least one other heat transfer machine. Method 200 may repeat step 216 until it produces a sufficiently strong molecular bond interface 20. The heat transfer machine(s) used for step 216 may have a rigid, deformable, or flexible pressure application tool.

In step 220, method 200 removes polymer carrier substrate 61 from coating 50.

In optional step 222, method 200 cuts ornamental vinyl building article 100 into segments of predetermined length and/or width.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “substantially” or “approximately” as used herein may be applied to modify any quantitative representation that could permissibly vary without resulting in a change in the basic function to which it is related.

What is claimed is:

1. An ornamental vinyl building article comprised of:
a high-strength extruded base having at least a first external surface and a second external surface,
wherein said high-strength extruded base is comprised of polyvinyl chloride (PVC), nanoscale particles of chemically synthesized calcium carbonate, at least one foaming agent, at least one non-orthophthalate PVC plasticizer, at least one lubricant, at least one non-PVC thermoplastic polymer as a toughening agent, and at least one thermal stabilizer; and
a molecular bond interface located between a variable texture pattern layer and said first external surface.

2. The article of claim 1 wherein said article is multi-dimensional.

3. The article of claim 1 wherein said article is planar with a textured surface.

4. The article of claim 3 wherein said textured surface is a smooth surface.

5. The article of claim 1 wherein said nanoscale particles of chemically synthesized calcium carbonate have an average diameter of between approximately 50 nm and approximately 500 nm.

6. The article of claim 1 wherein said nanoscale particles of chemically synthesized calcium carbonate are precipitated nanoscale particles of chemically synthesized calcium carbonate.

7. The article of claim 1 wherein said nanoscale particles of chemically synthesized calcium carbonate have a crystal shape selected from the group consisting of: scalenohedral, rhombohedral, prismatic, and orthorhombic.

8. The article of claim 1 wherein said at least one non-orthophthalate PVC plasticizer is dioctyl terephthalate.

9. The article of claim 1 wherein said at least one lubricant is selected from a group consisting of: hydrocarbon-based lubricants and fatty acid-based lubricants.

10. The article of claim 1 wherein said at least one lubricant is paraffin.

11. The article of claim 1 wherein said at least one non-PVC thermoplastic polymer is acrylonitrile butadiene styrene (ABS).

12. The article of claim 1 wherein said at least one thermal stabilizer is calcium and zinc based.

13. The article of claim 1 wherein said high-strength extruded base further includes between approximately 1 wt % and approximately 2 wt % of stearic acid.

14. The article of claim 1 wherein said first external surface is harder than said second external surface.

15. The article of claim 1, further including a transparent coating connected to said variable texture pattern layer, wherein said transparent coating is selected from the group consisting of aluminum oxide and urethane.

16. The article of claim 15 wherein said transparent coating is bound to said variable texture pattern layer by an adhesive layer.

17. The article of claim 16 wherein said adhesive layer is a silicone-based adhesive.

18. The article of claim 1 wherein said article contains an effective amount of calcium carbonate to render it inflammable.

19. The article of claim 1 wherein said high-strength extruded base has at least one hollow chamber.

20. The article of claim 19 wherein said at least one hollow chamber extends along a long axis of said article.

21. The article of claim 1 wherein said nanoscale particles of chemically synthesized calcium carbonate have an average diameter of below approximately 1000 nm.

22. A method of manufacturing an ornamental vinyl building article comprised of the steps of:
(i). chemically synthesizing nanoscale particles of calcium carbonate;
(ii). preparing a composition comprising polyvinyl chloride (PVC), nanoscale particles of chemically synthesized calcium carbonate, at least one foaming agent, at least one non-orthophthalate PVC plasticizer, at least one lubricant, at least one non-PVC thermoplastic polymer as a toughening agent, and at least one thermal stabilizer;
(iii). extruding said composition to create a high-strength extruded bas;
(iv). cooling said high-strength extruded base;
(v). heating said high-strength extruded base to a molecular bonding temperature; and
(vi). forming a molecular bond interface between said variable texture pattern layer and a first external surface of said high-strength extruded base by applying pressure to said variable texture pattern layer and said first external surface with a pressure application tool.

23. The method of claim 22 wherein step (iii) extrudes said composition to include at least one hollow chamber extending in an extrusion direction in said high-strength extruded base.

24. The method of claim 22, which further includes the step of creating a variable texture pattern layer from a digitally stored pattern retrieved from electronic storage before step (vi).

25. The method of claim 24, which further includes the step of creating said digitally stored pattern with computer software before step (vi).

26. The method of claim 25, which further includes the step of performing a randomization algorithm to prevent patterns from repeating over time.

27. The method of claim 22, wherein said pressure application tool is a solid mass of deformable material.

28. The method of claim 22, wherein said pressure application tool is a porous mass of deformable material.

29. The method of claim 22, wherein said pressure application tool is a flexible membrane at least partially filled with at least one of a fluid or a plurality of particles.
